(19) United States
(12) Patent Application Publication
(10) Pub. No.: US 2003/0209013 A1
(43) Pub. Date: Nov. 13, 2003

(54) Piston air engine

(76) Inventor: Yu-Chi Tsai, Chang-Hua City (TW)

Correspondence Address: YU-CHI TSAI, PO BOX 487, Chang-Hua City 500, TW

(21) Appl. No.: 10/425,634

(22) Filed: Apr. 30, 2003

(30) Foreign Application Priority Data
May 9, 2002 (TW) 091206792

(51) Int. Cl. F16D 31/02

(52) U.S. Cl. 60/370

(57) ABSTRACT

A piston air engine comprises an intake system at an outer side of a cylinder and parallel to the cylinder; a piston in the cylinder; a piston inner exhaust valve device in an interior of the piston; and a piston positioning actuating device for actuating an engine and positioning in a power stroke. The lever force apply point of the intake lever is at an upper dead point of the piston to be confined by the movement of the piston; and the lever force accept point of the intake lever is installed at the intake valve door for confining the intake valve.

### FIELD OF THE INVENTION

The present invention relates to engines, and particularly to a piston air engine which can be used as a two-cylinder engine or a multiple-cylinder engine.

### BACKGROUND OF THE INVENTION

In U.S. Pat. No. 6,006,517 and U.S. Pat No. 6,085,631, prior art toy used engines are disclosed, which only use at a short time period, and thus they are not suitable to be used in practical engines. In U.S. Pat. No. 6,600,517, the central axial line of a cylinder must be vertically connected to the air outlet of air storage bottle, and only one cylinder is used. For the U.S. Pat. No. 6,085,631, a piston skirt is disclosed. However this design is only used at some finite frequencies. Thereby, it is not suitable to a long time and high power operation of an engine.

However air engine has the advantage of saving power and reducing environment pollution.

### SUMMARY OF THE INVENTION

Accordingly, the primary object of the present invention is, to provide A piston air engine comprises an intake system at an outer side-of a cylinder and parallel to the cylinder; a piston in the cylinder; a piston inner exhaust valve device in an interior of the piston; and a piston positioning actuating device for actuating an engine and positioning in a power stroke. The lever force apply point of the intake lever is at an upper dead point of the piston to be confined by the movement of the piston; and the lever force accept point of the intake lever is installed at the intake valve door for confining the intake valve.

The various objects and advantages of the present invention will be more readily understood from the following detailed description when read in conjunction with the appended drawing.

### BRIEF DESCRIPTION OF THE DRAWINGS

FIG. 1 is a corresponding showing a base configuration of the present invention.

FIG. 2 shows the hollow piston exhausting device of the present invention.

FIG. 3 shows the intake system of the present invention.

FIG. 4 shows the interconnection of the intake device and the exhausting device of the present invention.

FIG. 5 shows another interconnection of the intake device and the exhausting device of the present invention.

FIG. 6 shows a further interconnection of the intake device and the exhausting device of the present invention.

FIG. 7 shows a yet interconnection of the intake device and the exhausting device of the present invention.

FIG. 8 shows the other interconnection of the intake device and the exhausting device of the present invention.

FIG. 9a shows the principle for automatically starting the engine in the piston positioning and actuating device is illustrated.

FIG. 9b shows the starting way of a single cylinder engine and multiple cylinder engine as a crank rotates through 360 degrees.

FIG. 10a is a front view of an embodiment of the present invention which is used in a two cylinder engine.

FIG. 10b is a right view of an embodiment of the present invention which is used in a two cylinder engine.

FIG. 11a is a schematic view showing that the present invention is used in a multiple cylinder engine.

FIG. 11b is a cross sectional view showing that the present invention is used in a multiple cylinder engine.

FIG. 11c is another cross sectional view showing that the present invention is used in a multiple cylinder engine.

### DETAILED DESCRIPTION OF THE PREFERRED EMBODIMENTS

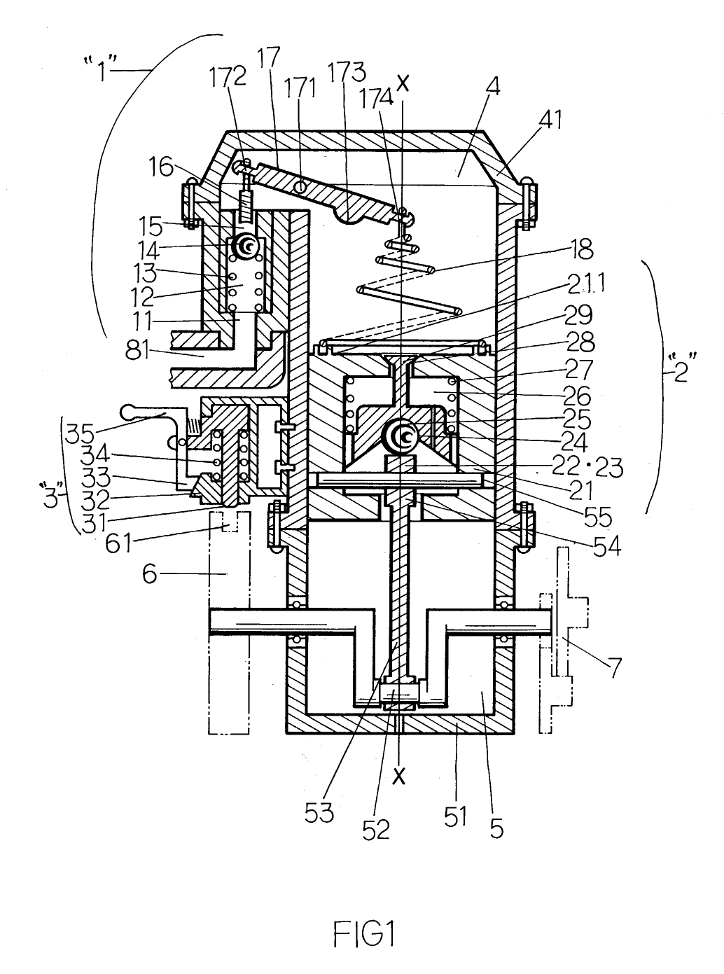

Referring to FIG. 1, the present invention is illustrated. In that, the present invention includes an intake system 1, a hollow piston exhausting device 2, a piston positioning actuating device 3, a cylinder house 4, a crank case 5, a fly wheel 6, a gear set 7 and an air supply tube 81. The intake system 1, hollow piston exhausting device 2 and piston positioning actuating device 3 are primary items of the present invention.

The intake system 1 is a tube like body adhered to an outer wall of the cylinder 4. A front end of the intake system 1 is a joint 11 for being connected to an supply assembly of the air supply tube 81. The intake gate 15 at the distal end of the intake system 1 has an intake valve tappet 16. The intake valve tappet 16, intake tank 12, intake valve spring 13, intake ball valve 14, and intake gate 15 are formed as a check intake valve. An intake lever 17 runs between the intake gate 15 and cylinder 4. The intake lever 17 is placed on an engine cover 41 by using a fulcrum 171. The level force accept point 172 is aligned to the intake gate 15 and hangs upon the intake valve tappet 16. The force apply point 173 is installed at a position which can be collided by a piston 21 as the piston 21 returns to be near a dead point. A wide opening of the cone spring 18 receives the spring groove 211.

The hollow piston exhausting device 2 is installed along a central axis or shifted from the central axis of the piston 21. The hollow piston exhausting device 2 has a front opening exhaust valve 28, an exhaust valve groove 26, an exhaust valve spring 27and an exhaust valve 29 so as to form a check exhaust valve device. Moreover, a sector rocker 22, an actuating cam 23 and a follow cam 25 are included so as to form a cam chain.

The piston positioning actuating device 3 includes an elastic lock pin 31, a steer rod 35, a steer hook 33, a support hook 32, a released spring 34 and an index hole 61 installed on the fly wheel 6. The elastic lock pin 31 is inserted into a positioning hole for lock the piston 21 to an engine start point. The positioning hole 61 can be installed to the gear set 7, propeller, etc.

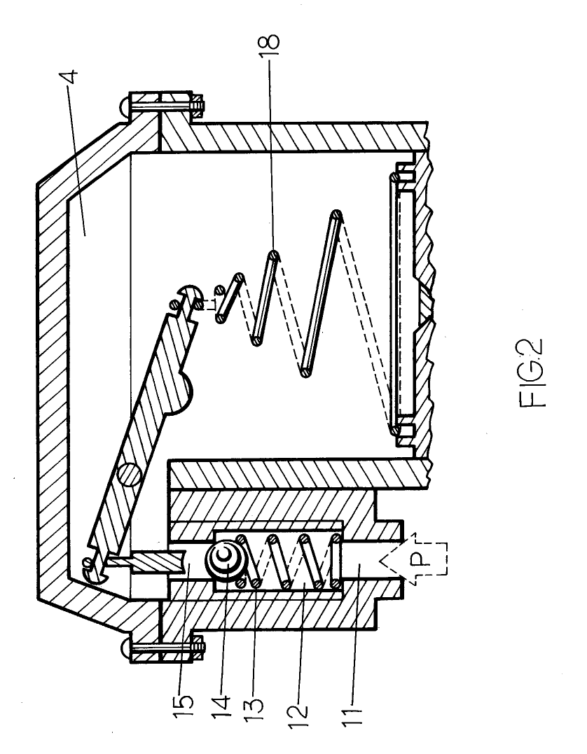

FIG. 2 shows the operation of the exhausting of the piston. It is shown that the crank pin 52 rotates clockwise. The crank pin 52 rotates to 0 degree that is a position of the lower dead point of the piston. The crank pin 52 rotates to 180 degrees which is a position of the upper dead point of the piston. The crank pin 52 rotates from 0 to 180 degrees which is the power stroke of the piston. The crank pin 52 rotates from 180 to 0 degrees which is release stroke of the piston.

The collar 54 of the piston linkage 53 is engaged to an outer end of the piston pin 55. One end of the sector rocker 22 is installed with an actuating cam 23. The actuating cam 23 and a follower cam 25 are formed as a sliding contact. The follow cam 25 is placed in a ball socket 24 by spherical pairing. When the sector rocker 22 drives the actuating cam 23, the cam 23 enforces the exhaust valve 29 and the exhaust valve 28 to open and close intermittently.

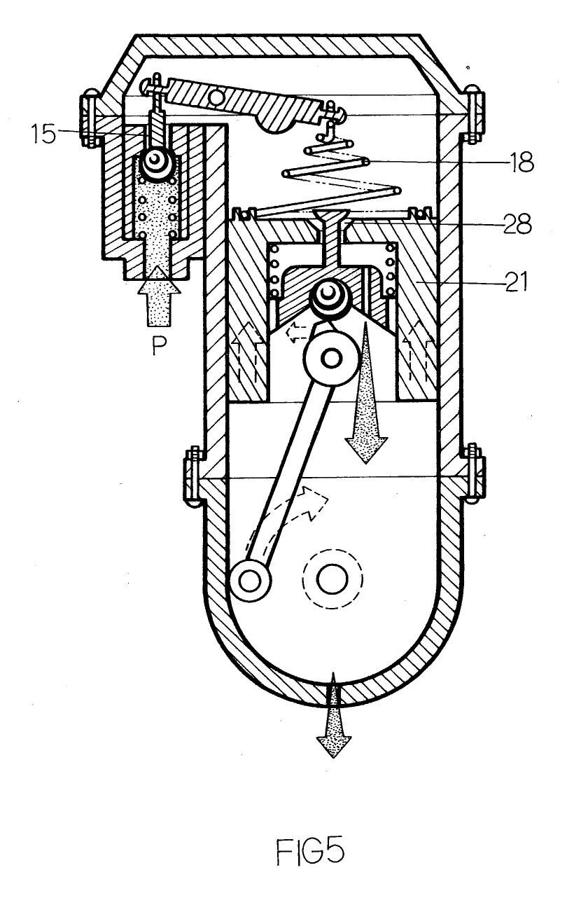

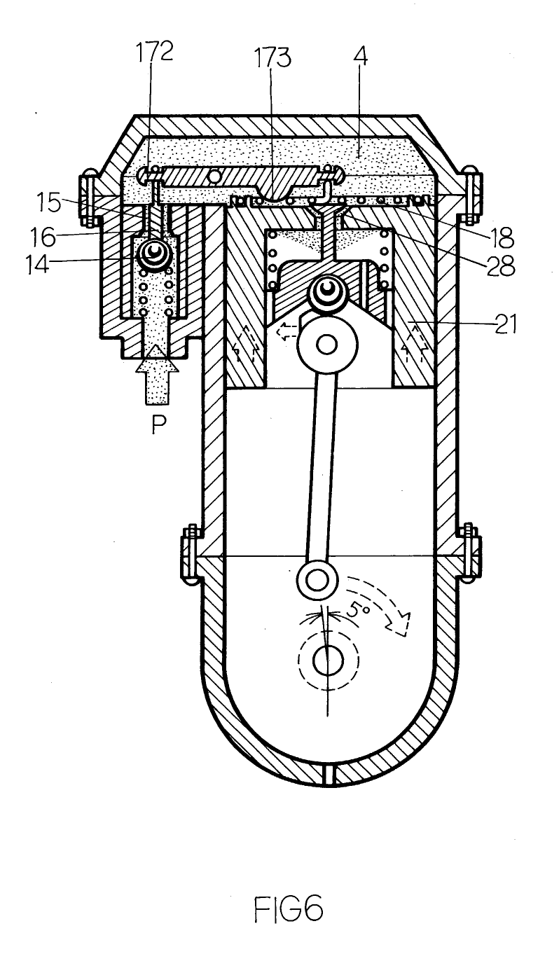

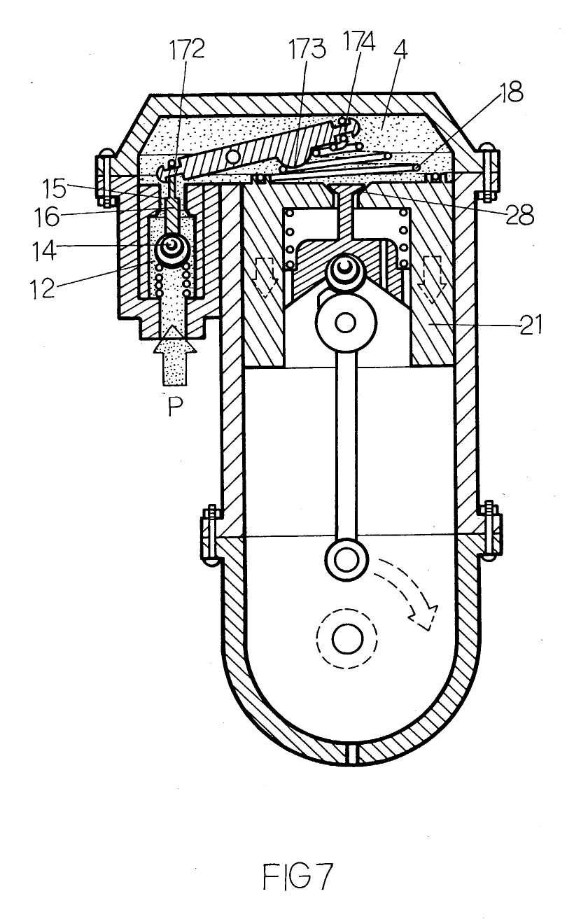

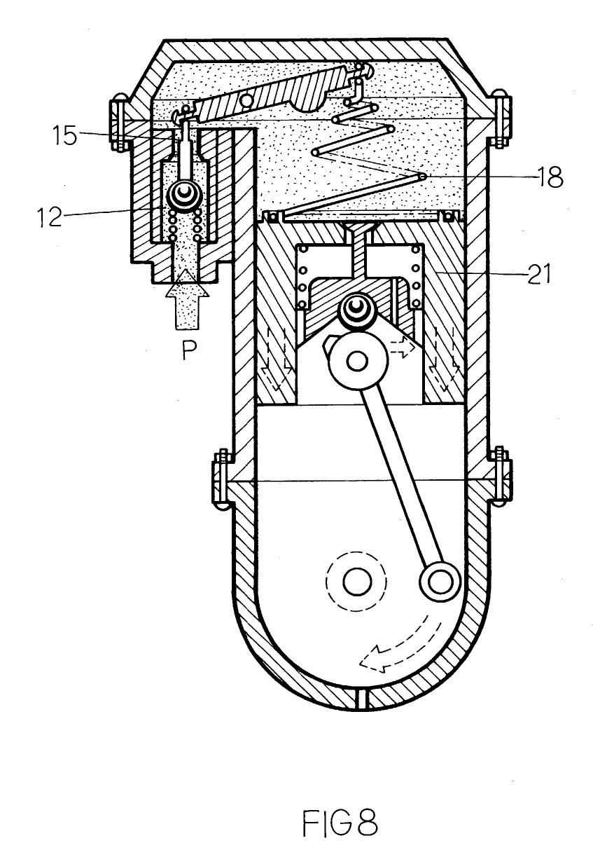

In FIG. 2, the piston 2 is at a lower dead point. The actuating cam 23 is exactly in contact with the follow cam 25 but does not press the cam 25. The exhaust valve 29 and exhaust valve door 28 close now. The piston 21 passes through the lower dead point and returns. The sector rocker 22 moves rightwards (referring to FIG. 5). The actuating cam 23 presses the follow cam 25 so that the exhaust valve 29 opens the exhaust valve door 28 to release pressure. When the piston 21 returns to one half of the return path, the cam pin 52 is at a position of 270 degrees. The cams 23 and 25 are deeply pressed to one another. The exhaust valve door 28 opens to a maximum position. Then the sector rocker 22 swings leftwards (referring to FIG. 6). The two cams 23 and 25 slightly press to one another to close the exhaust valve door 28. When the piston 28 returns to an upper dead point, the crank pin 52 is at a 0 degree position, the two cams 23 and 25 are released to one another. Then the exhaust valve door 28 closes (referring to FIG. 7). Then, the piston 21 passes through the upper dead point to a power stroke. The sector rocker 22 swings leftwards continuously. The two cams 23 and 25 separates. Then the exhaust valve door 28 closes continuously. When the piston 21 arrives one half of the power stroke, i. e. , the crank pin 52 at a 90 degree position, the sector rocker 22 swings rightwards. The exhaust valve door 28 closes (referring to FIG. 8). Then the piston 21 closes to a lower dead point.

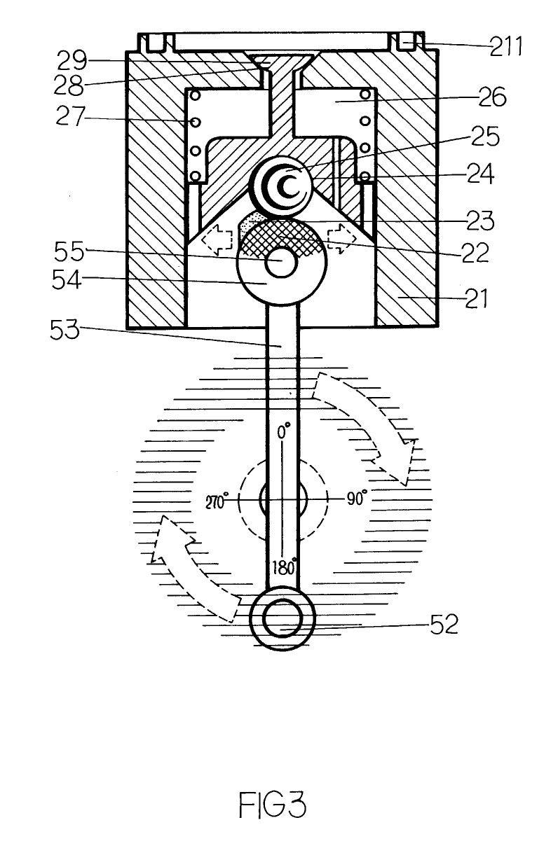

Referring to FIG. 3, the arrow P in the air supply joint 11 represents high pressure air from the air supply system. The high pressure air P stops in front of the ball valve 14. The intake groove 12 and cylinder 4 have pressure difference. When the intake gate 15 opens, the air enters into the cylinder 4 so that pressure in the groove 12 and the cylinder 4 are in balance. In the present invention, the spring 13 and 18 must match the follow conditions:

(1) The elastic force of the cone spring 18<elastic force of the intake valve spring 13+pressure 18.

(2) The elastic force of the cone spring 18>elastic force of the intake valve spring 13.

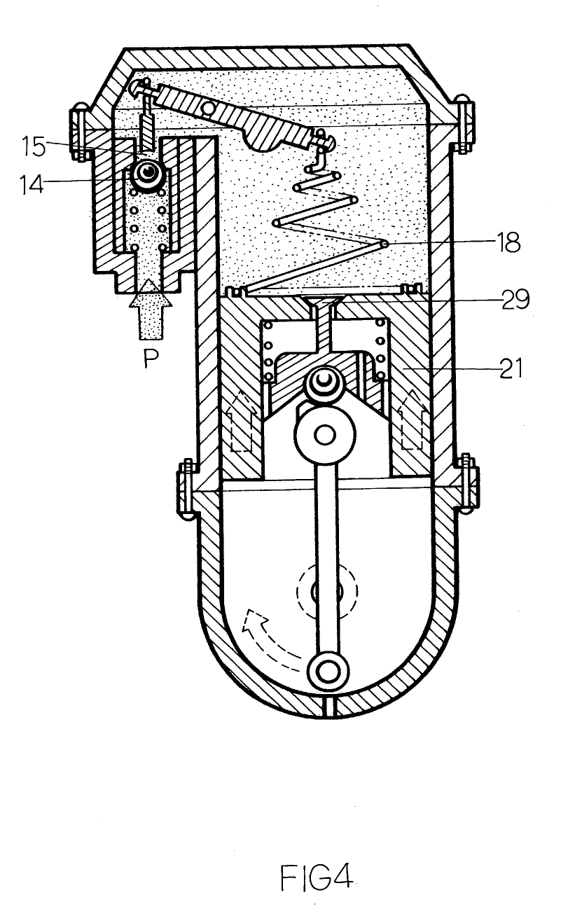

Referring to FIG. 4, the piston 21 is at a lower dead point. The spring 18 loses of elastic force. The first condition causes that the ball valve 14 closes the intake gate 15. Then the piston 21 passes ;k the lower dead point to be in return pass, the exhaust valve 29 is opened by cams. The cam 21 presses the cone spring 18

With reference to FIG. 5, the piston 21 arrives one half of the return path, the exhaust valve door 28 releases pressure. The cone spring 18 compresses and the intake gate 15 remains in close position. The piston 21 is near the upper dead point.

Referring to FIG. 6, the piston 21 returns to be near the upper dead point, the cone spring 18 is compressed near a plane. The piston 21 collides the lever force apply point 173 by the inertia of the fly wheel so that the lever force accept point 173 compresses the intake valve tappet 16 to open the ball vale 14. The high pressure P enters into the cylinder 4 through the intake gate 15. Since exhaust valve door 28 release only a little pressure, the piston 21 passes through the upper dead point at 1/6000 second (under a rotation speed of 500 rpm). The harm of the reverse pressure is reduced to a minimum.

FIG. 7 shows that the piston 21 is at an upper dead point. It is shown that the intake groove 12 and the cylinder 4 are in high pressure balance due to early air input. The condition from condition (1) to condition (2). The elastic force of the cone spring 18 will replace the lever force apply point 173 by the force applying point 174 to press the ball valve 14. In FIG. 8, the piston 21 has arrived the 90 degree position. Since in the intake lever chain in at condition (2) so as to supply air continuously until the elastic force of the cone spring 18 is exhausted. The intake valve spring 13 is resilient to enforce the ball valve 14 to seal the intake gate 15 so that the condition is changed from (2) to (1) to return to the condition of FIG. 4. Thereby, in the present invention, it is only necessary to adjust the springs 12 and 18, the power efficiency can be increased.

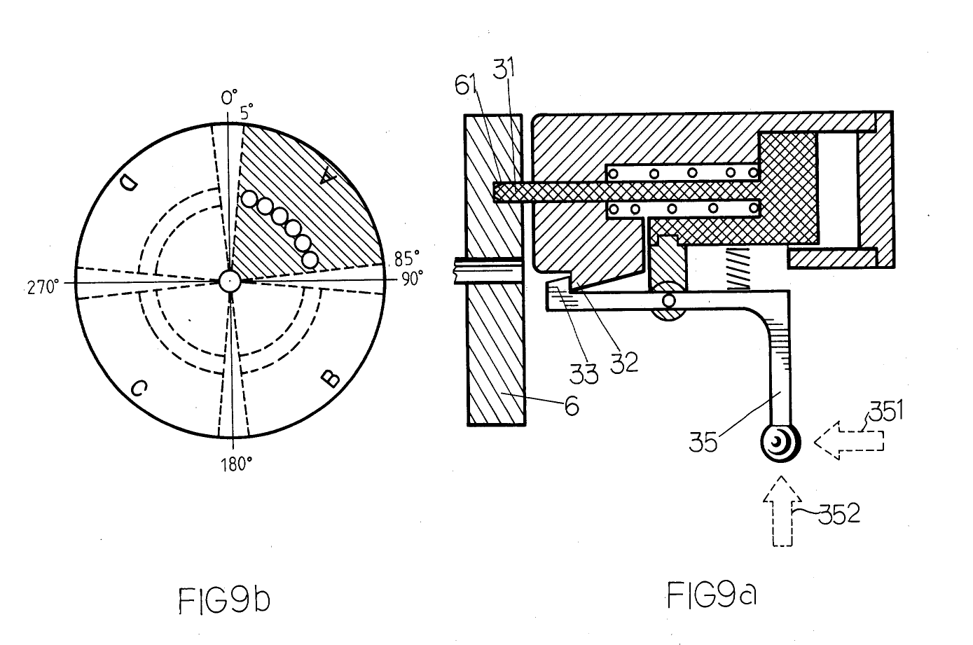

Referring to FIG. 9a, it that, the principle for automatically starting the engine in the piston positioning and actuating device is illustrated. In FIG. 9b shows the starting way of a single cylinder engine and multiple cylinder engine as a crank rotates through 360 degrees.

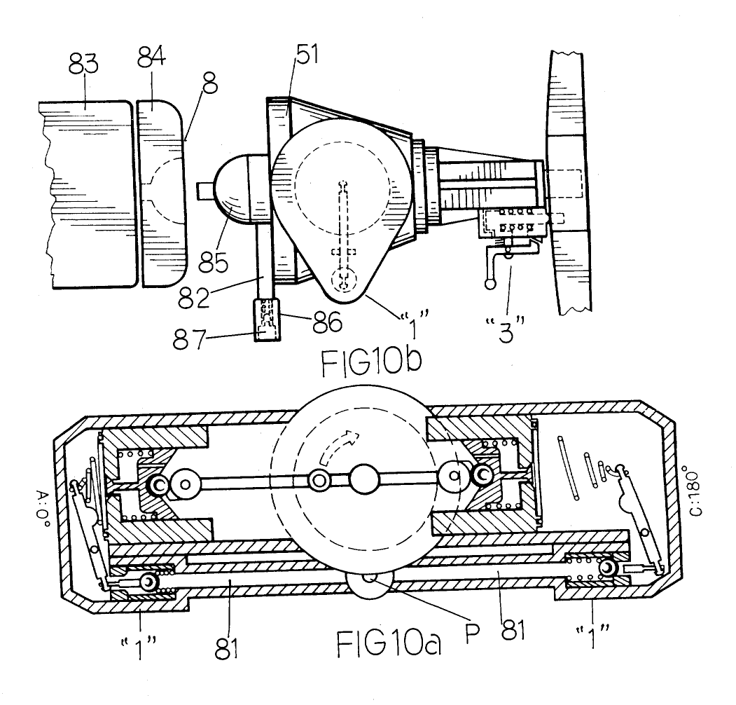

FIGS. 10a and 10b show that the present invention is used to a two cylinder engine of a model plane. In that, two independent cylinders are used the same crank case 5. The piston positioning actuating device 3 is positioned below a driving shaft; the index hole is, installed on a propeller. The intake system 1 are parallel installed at a lower side the two cylinders. Each is connected to an air supply pipe P to an air supply system 8. The air supply system includes an air supply conduit 82, an air storage bottle 83, a cover 84, a joint 85. One end of the joint 85 is connected to the cover 84. Another end thereof is hidden in the joint 85. The conduit 82 extends from a middle section. A distal end of the air inflation conduit 82 is installed with a check air inflation valve 86 and an air inlet 87.

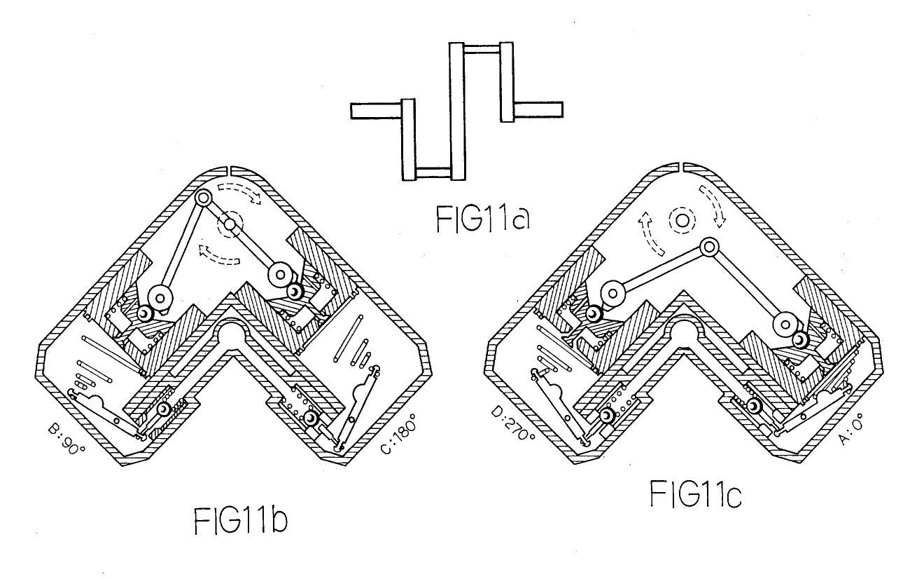

FIGS. 11a to 11c show one the present invention of the present invention. FIG. 11a is a schematic view showing that the present invention is used in a multiple cylinder engine. FIG. 11b is a cross sectional view showing that the present invention is used in a multiple cylinder engine. FIG. 11c is another cross sectional view showing that the present invention is used in a multiple cylinder engine.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A piston air engine comprising:
an intake system at an outer side of a cylinder and parallel to the cylinder;
a piston in the cylinder; a piston inner exhaust valve device in an interior of the piston; and
a piston positioning actuating device for actuating an engine and positioning in a power stroke.

2. The piston air engine as claimed in claim 1, wherein the intake system further comprises:
a tube body parallel adhered to an outer wall of the cylinder; a front opening of the intake system being an air intake joint for being connected to a gas manifold which is connected to an air intake device for receiving gas;
an air intake gate at an opening at one end of the tube body; the air intake gate being communicable to a cylinder housing of the cylinder; an interior of the air intake gate has an air intake valve tappet; and
an air intake valve groove between the air intake joint and the air intake gate; an intake spring and an intake ball valve being received in the air intake gate; the intake spring resisting against the intake ball valve so as to seal the air intake valve to formed a check air intake device, in that, the air intake gate is controlled by an intake level.

3. The piston air engine as claimed in claim 2, wherein the air intake level runs across the air intake gate and the cylinder housing; a fulcrum at a middle section of level is firmly secured to an interior of an engine cover at one end of the cylinder; one end of the air intake level is connected with the air intake valve tappet as a force receiving point; another end of the air intake level is formed as a force applying point; the force applying point is at a position which is collided as the piston returns to an upper dead point; an edge of the force applying point is provided for suspending a narrow opening of a tapered spring as a force applying point of the tapered spring; a wide opening of the tapered spring is buckled to a piston spring groove of a piston inner exhausting device for linking the air intake device and an air exhausting device.

4. The piston air engine as claimed in claim 3, wherein the force applying point of the air intake level is at an upper dead point of the piston, which is limited by the upper and lower movement of the piston; the force receiving point of the air intake level is installed at the air intake gate for confining an air intake valve.

5. The piston air engine as claimed in claim 1, wherein piston inner exhaust valve device has an exhausting gate at an piston opening; the air exhausting gate penetrates through an exhausting valve groove within the piston;
an exhausting valve spring and an exhausting valve are installed in the exhausting valve groove; an exhausting valve hole is formed in a predetermined position of the exhausting valve in the exhausting valve groove for opening or closing the exhausting gate; a bottom of the exhausting valve is formed with a bead recess; a driven cam located in the bead recess; a bottom of the piston is transversally installed with a piston pin;
an axial ring formed at one end of a piston linkage is axially pivoted to a piston pin so that the axial ring is received in the exhausting valve groove and one end of the axial ring is adhered to the driven cam; and
an actuating cam is mounted at another end of the axial ring; thereby, by operation the piston linkage, the exhausting valve is driven to open or close intermittently.

6. The piston inner exhaust valve device as claimed in claim 5, wherein the piston inner exhaust valve device is installed at a central axis of an interior of the piston.

7. The piston inner exhaust valve device as claimed in claim 5, wherein the piston inner exhaust valve device is installed eccentrically to a central axis of an interior of the piston.

8. The piston inner exhaust valve device as claimed in claim 1, wherein the piston positioning actuating device is assembled by a telescopic pin, a steering rod, a steering hook, a connecting hook, and a pin retracting spring for controlling the insertion and retraction of a pin from a positioning hole of a flywheel to be as a positioning device; the flywheel is assembled to an edge of a crank pivotally installed to one end of the piston linkage and the inserting hole is formed a return path at the piston passing through an upper dead point.

9. The piston inner exhaust valve device as claimed in claim 7, wherein the flywheel is a rotary means for being inserted by the telescopic pin so that the piston is locked to a power stroke.

10. The piston inner exhaust valve device as claimed in claim 1, wherein piston positioning actuating device is installed to a multiple cylinder air engine, a control disk of the piston positioning actuating device is divided into a plurality of positioning sections corresponding to the number of the cylinders; the positioning sections are spaced by dead points of the positioning sections.
